(19) United States
(12) Patent Application Publication
(10) Pub. No.: US 2006/0252873 A1
(43) Pub. Date: Nov. 9, 2006

(54) IC trays and compositions thereof

(75) Inventor: Kim G. Balfour, Delanson, NY (US)

Correspondence Address: GEAM - LNP-CE 08CE;IP LEGAL, ONE PLASTICS AVENUE, PITTSFIELD, MA, 01201-3697, US

(73) Assignee: General Electric Company

(21) Appl. No.: 11/122,963

(22) Filed: May 5, 2005

(51) Int. Cl. C08G 18/42

(52) U.S. Cl. 524/500

(57) ABSTRACT

The present invention relates to a composite resin composition which consists essentially of an amorphous resin such as polyphenyleneoxide or polyphenylene ether at the amount of 20 to 80 wt % of total composition weight; one or more crystalline resins selected from the group consisting of polyamides and polyolefins in the amount of 3 to 40 wt %; and glass fiber or inorganic fillers in an amount of 1 to 50 wt % of total composition weight. The presence of the crystalline resins allows the shrinkage rate of articles molded from the composition, e.g., IC trays, to be controlled within desired specifications.

### FIELD OF THE INVENTION

This invention relates to electronic packaging components, e.g., trays for an integrated circuit or large-scale integrated circuit (hereinafter referred to as “IC”).

### BACKGROUND OF INVENTION

Trays for heat treatment of IC are used in the field of electric and electronic engineering for conveying, or drying for dehydrating IC parts. In the prior art, the trays are produced by molding a composition consisting essentially of an amorphous resin such as polyphenylene ether, polyetherimide, polysulfone, or polyethersulfone with about 2-20 wt. % carbon powder. The amorphous resins provide a predictable dimensional control for molders, plus allowing the IC parts to be heat-resistant at temperature of up to 200° C. In addition to prime or virgin resins, some IC tray manufacturers/molders add fillers (regrind resin feed) of <25 to 50 wt. % to the IC compositions. Due to the presence of fillers such as glass fiber and minerals, regrind feed typically have shrink rates of less than 0.08% when employed in IC tray compositions.

There is a need in the art of compositions with a high rate of shrinkage to use as a blending aid in reducing the shrinkage of the regrind feed stream. There is also the need for a method to control the shrinkage of IC compositions, allowing manufacturers to tailor the feed shrinkage rate unique to their tooling facility.

### SUMMARY OF THE INVENTION

The invention relates to a composition consisting essentially of 20 to 80 wt. % of an amorphous resin selected from the group consisting of polyphenyleneoxide, polyethersulfone, polysulfone, polyetherimide, and mixtures thereof; 3 to 30 wt. % of a crystalline resin selected from the group consisting of polyamide, high molecular weight polyolefins and mixtures thereof; and fillers in an amount of 1 to 50 wt. % In one embodiment of the invention, the composition further comprises 2 to 30 wt. % of a carbon black material.

The invention further relates to a composition consisting essentially of 40 to 80 wt. % of polyphenylene oxide, 3 to 30 wt. % of polyamide, and 2 to 20 wt. % of carbon black powder.

The invention also relates to a method to control the shrinkage rate in molded articles comprising amorphous resins, by the addition of 3 to 30 wt. % of a crystalline resin selected from the group consisting of high molecular weight polyolefins and mixtures thereof, for a shrinkage rate of >0.10%.

Lastly, the invention further relates to IC trays consisting essentially of 10 to 80 wt. % of an amorphous resin selected from the group consisting of polyphenyleneoxide or polyphenylene ether, polyethersulfone, polysulfone, polyetherimide, and mixtures thereof; 3 to 30 wt. % of a crystalline resin selected from the group consisting of polyamide, high molecular weight polyolefins and mixtures thereof, having a shrink rate of greater than 0.10%.

### BRIEF DESCRIPTION OF THE INVENTION

The composition of the invention, suitable for IC trays, comprises an amorphous resin along with a sufficient amount of a crystalline resin for a shrinkage rate of >0.10%. The high shrinkage rate of the composition of the invention allows molders to substantially increase the use of low cost regrind materials (having low shrinkage rate of 0.05 to 0.08%) for IC trays with excellent mechanical strength, dimensional stability, and controlled linear expansion coefficient (or shrinkage rate). In one embodiment of the invention, the composition further comprises a conductive component such as carbon powder, graphite, and the like.

Amorphous Component. The amorphous component in the composition of the invention is present in an amount of 20 to 80 wt. % of the total composition. The amorphous material is selected from the group consisting of polyphenyleneoxide, polyethersulfone, polysulfone, polyetherimide, and mixtures thereof. In one embodiment, the amorphous component is present in an amount of 40 to 70 wt. %. In another embodiment, from 45 to 65 wt. %.

In one embodiment, the amorphous component is a polyphenylene oxide or polyphenylene ether. Polyphenylene ethers may be prepared by any of a number of catalytic and non-catalytic processes from corresponding phenols or reactive derivatives thereof, referring to unsubstituted polyphenylene ether (made from phenol), polyphenylene ethers substituted with various substituents, polyphenylene ether copolymers, as well as graft copolymers and block copolymers. Polyphenylene ethers are commercially available from General Electric Company (“GE”) of Pittsfield, Mass.

In one embodiment, the amorphous component is an aromatic polysulfone resin. As used herein, an aromatic polysulfone is defined as a polyarylene compound comprising three essential constituent units of an arylene unit, an ether bond and a sulfone bond. The arylene unit is situated randomly or orderly together with the ether and sulfone bonds. Examples include polyether sulfones, polyaryl ether sulfones, polyphenylene ether sulfones, and polybiphenyl ether sulfolle resins.

In another example of the invention, the amorphous component comprises a high-performance thermoplastic resin such as polyetherimide marketed by GE Plastics under the trade name Ultem, or a blend of a polyetherimide with any of the polyphenyleneoxide, polyphenylene, polyethersulfone, or polysulfone. Polyetherimides are derived from reaction of aromatic dianhydrides or aromatic tetracarboxylic acids or their derivatives capable of forming cyclic anhydrides, and aromatic diamines or their chemically equivalent derivatives, to form cyclic imide linkages.

In one embodiment of the invention wherein the amorphous component is polyphenylene oxide or polyphenylene ether, the composition may further comprise 1 to 40 wt % of polystyrene or polycarbonate to give the composition improved injection fluidity in the molding process and IC trays with smoother surface. In one embodiment of the invention, the composition further comprises 5 to 20 wt. % of a polystyrene. In another embodiment, 7 to 15 wt. % of high impact polystyrene (HIPS).

Crystalline Resin Component: Applicants have found that the addition of at least a crystalline resin in a sufficient amount to control the shrinkage rate of parts molded from the composition of the invention to greater than 0.10%. In one embodiment, the crystalline component is 3 to 30 wt. %. In another example, in a range of 5 to 25 wt. %. In yet a third example, from 5 to 22 wt. %. In a fourth embodiment, from 10 to 20 wt. %. The crystalline component is selected from the group of polyamides, polyolefins, or mixtures thereof. In one embodiment, the crystalline component is nylon 6. In another example, the crystalline component is nylon 66 in an amount of 15 to 22 wt. %.

In one embodiment of the invention, the crystalline resin is a polyamide. Polyamides can be obtained by a number of well-known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl) methane; 2,2-di-(4-aminophenyl)propane, 2,2-di-(4-aminocyclohexyl)propane, among others. Copolymers of caprolactam with diacids and diamines are also useful.

The “polyamides” herein also include toughened or super tough polyamides. Super tough polyamides, or super tough nylons as commonly known, e.g. are commercially available from E.I. duPont and other companies.

In another embodiment, the crystalline resin is a polyolefin. The polyolefin includes homopolymers and copolymers of ethylene, propylene, butene, 4-methylpentene, and the like; random, block or graft copolymers with polar monomers such as vinyl acetate, acrylic acid, acrylic ester, maleic anhydride and the like.

In one embodiment, the crystalline component is a polypropylene. Such polypropylene may be a copolymer containing propylene as a main component and an ethylene component, e.g., propylene-ethylene block copolymer, block copolymer of propylene and ethylene-propylene rubber, etc.

In one embodiment, the crystalline component is selected from the group of polyethylene, polypropylene, polybutylene, polypentene, and substitution products thereof. In one example, the polyolefins are modified. In another example, the polyolefin is a high molecular weight polyolefin. In another embodiment, the crystalline component is an ultra-high molecular weight polyolefin. As used herein, “high molecular weight polyolefin” refers to polyolefins, which have a molecular weight of at least 150,000. “Ultra-high molecular weight polyolefin” refers to polyolefins having very large molecular weight, i.e. 800,000 or more. Examples include ultra-high-molecular-weight polyethylene with a low frictional characteristic.

Conductive Carbon Filler Component. The composition further comprises from 2 to 20 wt. % of a conductive component, e.g., a carbonaceous filler material. In one embodiment, the amount of conductive carbon component is from 3 to 10 wt. %. The use of over 10 parts by weight of some carbonaceous filler material may make the processing/molding of IC trays difficult due to increasing of melt viscosity of the composition.

Examples of the conductive component include carbon fibrils, single-walled carbon nanotubes, multi-walled carbon nanotubes, vapor grown carbon fibers, carbon black, graphite, a pulverized expansive graphite, fluorinated carbons prepared by fluorinating those carbons completely or partly, or a mixture comprising one or more of the foregoing carbonaceous fillers.

Examples of carbon fibers include all types of fibers obtained by calcining and carbonating fibers prepared using polyacrylonitrile (PAN), pitch or the like as a raw material in an inert atmosphere at a temperature between 1,0000 and 3,500° C. In one embodiment, the fiber has a diameter of 1 to 30 μm.

In one embodiment, the conductive component is carbon black powder having a DBP oil absorption of 150 ml/100 g or more. The DBP (dibutyl phthalate) oil absorption means the oil absorption defined in ASTM-D2414-88. Carbon black are commercially available from Degussa, Ensaco and Cabot Corporation. In one embodiment, two or more conductive carbon blacks having different DBP oil absorptions are used. Carbon fibrils are commercially available from Hyperion Catalyst.

Optional and Filler Components. In addition, the composition may further contain thermosetting resin and filler components. Fillers may be present in an amount of 1 to 50 wt. %. In one embodiment, the fillers are mica in 5 to 30 wt. %.

The thermosetting resin includes, for example, phenolic resin, epoxy resin, etc. The filler includes, for example, an abrasion-resistance improver such as silica powder, molybdenum disulfide, etc.; a reinforcing material such as glass fiber, aromatic polyamide fiber, alumina fiber, boron fiber, silicon carbide fiber, potassium titanate whiskers, aluminum borate whiskers, carbon whiskers, metal fiber, ceramic fiber, etc.; a flame retardancy improver such as antimony trioxide, magnesium carbonate, calcium carbonate, etc.; an anti-tracking improver such as asbestos, silica, etc.; an acid resistance improver such as barium sulfate, silica, calcium metasilicate, etc.; a thermal conductivity improver such as iron powder, zinc powder, aluminum powder, copper powder, etc.; and others such as glass beads, diatomaceous earth, alumina, shirasu balloons, hydrated alumina, hydrotalcite, zeolite, metal oxides, etc. Colorants, stabilizers, mold release agents, and plasticizers may be added to the composition within ranges not interfering with the effect of the invention.

Method For Manufacturing & Applications. The resin composition can be produced in any ordinary manner for continuous production, which comprises uniformly mixing the components and other optional components, followed by processing the resulting mixture, for example, in a single-screw or multi-screw extruder.

The composition can be molded into parts for high heat applications via methods of injection molding, extrusion molding, compression molding, transfer molding or the like. In one embodiment, the composition is used for producing large-area, tabular molded parts such as IC trays which will be demonstrated in the following Examples. The trays produced are widely used for heat treatment of IC. The IC trays of the present invention can be used in an atmosphere generally at a temperature up to 250° C.

In addition to IC trays (also called chip trays, the composition may also be used for trays equipped with a square pocket, trays equipped with a rectangular pocket and the like. Additionally, the composition of the present invention can be suitably used as a molding material for casing parts, covers, trays, or parts of automobiles, airplanes and the like, industrial instruments, domestic electric appliances, table wares and medical instruments, OA, AV instruments, electric parts, for example, semiconductor wafer carrier, LCD carrier, TAB tape carrier, IC socket and the like for which heat-resistance is required.

Examples: All cited references are incorporated herein by reference in their entirety. The invention is further illustrated by the following non-limiting examples.

In the examples, raw materials are mixed and kneaded at a temperature in the range of 270 to 300° C., then extruded to form pellets, and from the thus formed pellets, specimens and IC trays were prepared by means of injection molding. The compositions are molded into IC tray specimen. Shrinkage ratio of the molded articles are computed to be (shrinked quantity) divided by (total length of molded article)×100%.

The polyphenylene oxide used in the examples is from General Electric Company under the trade name “PPO” with an intrinsic viscosity of 0.40. Kraton G-1650 and K-1651 are elastomeric rubber additives Shells Company. HCC-1897 is a high impact polystyrene material. Conductive carbon black is Ketjin EC300 from Cabot Corporation. GLYCO PETS is a mold release agent. The stabilizer used is Irganox 1076 from Ciba-Geigy. The compatibilizers used are citric acid ANH CIAC and LIQ-KI. Polyamide Nylon 6, 6 and Nylon 6 are from DuPont.

The materials (other than carbon black) in the proportions specified in the Tables are used to first form master batch samples. The master batch samples are next diluted with 10 wt. % carbon black Ketjin EC300. Examples 6-8 are also referred the Figures and text as PDX-Z-03497, PDX-4323, N042904-1 and N042904-2, respectively.

TABLE 1

| | | | | | | Ex. 6 | Ex. 7 | | |
|---|---|---|---|---|---|---|---|---|---|
| | | | | | | PDX-Z- | PDX- | Ex. 8 | Ex. 9 |
| Component wt. % | Ex. 1 | Ex. 2 | Ex. 3 | Ex. 4 | Ex. 5 | 03497 | 4323 | N042904-1 | N042904-2 |
| polyphenylene oxide | 75.6 | 68.3 | 63.8 | 59.3 | 54.8 | 75.6 | 54.8 | 69.7 | 65.5 |
| Rubber K-1650 | — | — | — | — | — | 3.6 | — | — | — |
| Rubber K-1651 | 3.6 | 9 | 9 | 9 | 9 | — | 9 | 8 | 10 |
| Mold release agent | 0.9 | — | — | — | — | 0.9 | 9.9 | — | — |
| HIPS | 9.9 | 7.2 | 7.2 | 7.2 | 7.2 | 9.9 | 7.2 | 11.5 | 8.7 |
| Stabilizer IRG 1076 | — | 0.28 | 0.28 | 0.28 | 0.28 | — | 0.28 | 0.3 | 0.3 |
| Citric Acid | — | 0.45 | 0.45 | 0.45 | 0.45 | — | 0.45 | 0.5 | 0.5 |
| LIQ-KI | — | 0.27 | 0.27 | 0.27 | 0.27 | — | 0.45 | 0.5 | 0.5 |
| Nylon 6,6 | | | | | | — | 18 | — | — |
| Nylon 6 | — | 4.5 | 9 | 13.5 | 18 | — | — | 10 | 15 |
| Ketjin EC300 | 10 | 10 | 10 | 10 | 10 | 10 | 10 | 10 | 10 |

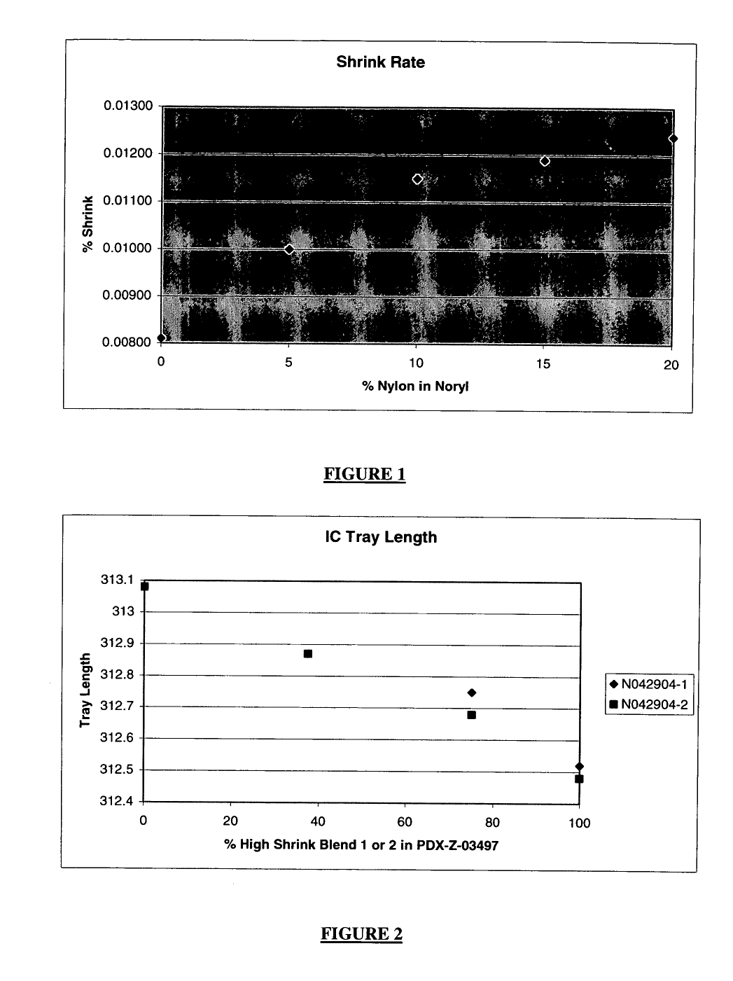

Resins from the examples 1-5 are blended and then molded into 0.5″×5″×0.125″ injection molded bars. FIG. 1 shows that the shrinkage rate increases as the polyamide loading level is increased in the samples.

Resins from Examples 6-10 are blended in different proportions as shown n Table 2. The blends are molded into IC trays and dimensions are then measured. The dimensions of the trays made from various examples are captured in Table 2 and also illustrated in FIG. 2. As shown, the IC tray with 312.52 mm size contains 100% of example 8 resin. Tray with 312.75 mm size contains 75% of Example 6 composition and 25% of Example 8 composition. Table 2 shows that as the amount of polyamide increases, the IC trays get shorter (more shrinkage). The sample with 0% polyamide (or 100% Example 5 PDX-Z-03497) measures 313.08 mm.

TABLE 2
Remainder - PDX-Z-03497

| % of PA composition | | 100 | 75 | 37.5 | 0 |
|---|---|---|---|---|---|
| Example 8 | N042904-1 | 312.52 | 312.75 | 312.87 | 313.08 |
| Example 9 | N042904-2 | 312.48 | 312.68 | 312.87 | 313.08 |

1. A thermoplastic composition consisting essentially of:
20 to 80 wt. % of an amorphous resin selected from the group consisting of polyphenylene oxide, polyethersulfone, polysulfone, polyetherimide, and mixtures thereof;
3 to 30 wt. % of a crystalline resin selected from the group consisting of polyamide, a high molecular weight polyolefin, and mixtures thereof; and
a filler in an amount of 1 to 50 wt. %.

2. The composition of claim 1, wherein the amorphous resin is polyphenylene oxide or polyethersulfone.

3. The composition of claim 1, wherein the crystalline resin is polyamide.

4. The composition of claim 1, wherein the crystalline resin is present in an amount of less than 20 wt. %.

5. The composition of claim 1, wherein the amorphous resin is present in an amount of 45 to 65 wt. %.

6. The composition of claim 1, further comprising 1 to 40 wt. % of a polystyrene, a polycarbonate, or mixtures thereof.

7. The composition of claim 1, wherein the filler is a conductive carbonaceous filler material selected from the group of single-walled carbon nanotubes, multi-walled carbon nanotubes, vapor grown carbon fibers, carbon black, graphite, a pulverized expansive graphite, a fluorinated carbon, and mixtures thereof.

8. The composition of claim 1, when molded into an article, gives a shrinkage rate of greater than 0.10%.

9. A thermoplastic composition consisting essentially of 45 to 65 wt. % of an amorphous resin selected from the group consisting of polyphenylene oxide, polyethersulfone, polysulfone, polyetherimide, and mixtures thereof; 3 to 30 wt. % of a crystalline resin selected from the group consisting of a polyamide, a polyolefin and mixtures thereof; 1 to 40 wt. % of a polystyrene, a polycarbonate, or mixtures thereof; and 1 to 50 wt. % of a carbocenous filler material.

10. A molded article which is obtained by molding a composition consisting essentially of 45 to 65 wt. % of an amorphous resin selected from the group consisting of polyphenylene oxide, polyethersulfone, polysulfone, polyetherimide, and mixtures thereof; 3 to 30 wt. % of a crystalline resin selected from the group consisting of a polyamide, a polyolefin and mixtures thereof; 1 to 40 wt. % of a polystyrene, a polycarbonate, or mixtures thereof; and 1 to 50 wt. % of a carbocenous filler material, and
wherein the molded article has a shrinkage rate of greater than 0.10%.

11. The molded article of claim 10, wherein the molded article is a casing, a cover, a tray or part thereof for an electronic device, an office automation device, a household appliance, or an automobile.
